(19) United States
(12) Patent Application Publication
(10) Pub. No.: US 2014/0259603 A1
(43) Pub. Date: Sep. 18, 2014

(54) Tension Relief System And Apparatus For Use With A Pipe Reduction Die

(71) Applicant: SAK CONSTRUCTION, LLC, O'FALLON, MO (US)

(72) Inventors: James H. Blasczyk, Friendswood, TX (US); William Gates, Humble, TX (US)

(73) Assignee: SAK CONSTRUCTION, LLC, O'FALLON, MO (US)

(21) Appl. No.: 14/206,440

(22) Filed: Mar. 12, 2014

Related U.S. Application Data
(60) Provisional application No. 61/785,121, filed on Mar. 14, 2013.

(51) Int. Cl. B29C 67/00

(52) U.S. Cl. CPC B29C 67/0014
USPC 29/426.1; 425/392

(57) ABSTRACT

Apparatus and method for removing a pipe liner from a diameter reducing die using a double nut system whereby the nuts are incrementally loosened to gradually relieve tension on the die until the assembly can be safely separated while reducing the risk of injury or damage to operators and equipment.

### CROSS REFERENCE TO RELATED APPLICATION(S)

This application claims benefit of U.S. Provisional Patent Application No. 61/785,121, filed Mar. 14, 2013, the entire disclosure of which is incorporated herein by reference.

### BACKGROUND

1. Field of the Invention

This disclosure is related to the field of pipe reduction systems, specifically to pipe reduction systems which use a rigid die to compress a plastic pipe liner for insertion into another pipe via a pulling force exerted by a towing head.

2. Description of the Related Art

Over time, the underground pipelines utilized for the transport of fluids or gases or other elements can become damaged, worn or corroded from use. In the past, the methodologies utilized for rehabilitating these underground or underwater pipelines were costly, labor intensive, and severely disruptive to the surrounding environment and communities.

Today, one of the primary methods and systems utilized in the prior art for rehabilitating existing pipeline systems and networks and to avert these problems is to line an existing pipeline with an extremely tight fitting polyethylene (PE) liner. In such a process, the liner has an outside diameter that is slightly larger than the inside diameter of the pipe being lined, sometimes called a host pipe. Because of the difference in diameter between the liner and the host pipe, the liner is pulled through a die to reduce its diameter before it enters the host pipe.

Generally, the liner is pulled through the die after sections of the liner are butt fused together to form a continuous string. The die temporarily reduces the diameter of the liner. This reduction allows the liner to be easily pulled through the outer existing pipe system. The die used in the prior art systems generally has an entry, a throat and an exit, with the entry decreasing in diameter towards the throat and increasing in diameter away from the throat. Thus, the liner has a maximum diameter before the die, a minimum diameter in the die, and an intermediate diameter after the die. In some embodiments, a heating element is used to apply heat to the liner prior to liner being reduced in the die, the heating element being used to facilitate the reduction of the liner. This is, however, generally less preferred.

The tension given to the liner by the die is generally maintained by a pulling element until the liner is correctly located within the installed pipeline. Commonly, the liner is pulled through the die and the existing pipe system by a winch or towing head. Generally, the force of pulling rendered by the winch or towing head is half the yield strength of the liner or less. It is not uncommon for the forces exerted on the die and winch or pulling head to be very large, often exceeding 50 tons.

Since the liner retains a memory of its original shape and size, it will begin to return to its original shape and diameter when the pulling force is disconnected. After the pulling force is disconnected, the liner relaxes and presses tightly against the inside of the existing pipeline to which it was applied, eliminating any annular space. FIG. 1 depicts the portion of the prior art process in which a new liner (101) is pulled through a reducing die (103) (thereby reducing its diameter) and into the existing pipeline (105) (at its reduced diameter) by a towing head (107) or winch.

Although the prior art process held numerous benefits for the industry, including reducing disruption, creating a strong new pipe, jointless construction, improved flow, and cost savings, the process also has numerous deficiencies in terms of costs, safety and efficiency. For example, current systems are generally performed at the level of the pipe. Stated differently, chambers at the level of the pipe (below ground or water) are excavated at each end of the existing pipeline that will be lined. The die of the system is placed within the excavated chamber at the front of the existing pipeline that will be lined. These chambers are costly and time intensive to build. In addition, the excavation involved in creating these chambers can be disruptive to both the environment and the community. Further, because the die is placed within the chamber in these systems, there is often not much space between the reducing die and the existing pipeline, as demonstrated in prior art FIG. 1.

This is problematic for a number of reasons, including that the large and dangerous force vectors associated with the system pose risks to laborers working in these restricted work areas. For example, disengagement of the reducing die can cause the release of hardware at a high velocity. Further, reduction dies are often comprised of two half-circular sections mated with hardware. When the reducing die is removed from the system under loaded conditions; i.e., the die is released from the liner while the liner is still under extreme pressure from both the towing head and the placement in the original pipeline system, one or both halves of the die may spring off the assembly at high velocity.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein is a tension release system which uses a threaded rod system to incrementally release tension on a pipe reduction die.

There is described herein, in an embodiment, a diameter-reducing die comprising: a generally annular top half comprising: a top interior side and an opposing top exterior side with a top terminal end extending therebetween; a top mating block rigidly attached to said top exterior side, said top mating block having a facing side generally coplanar with said top terminal end and an opposing threading side with a bore hole extending generally perpendicularly therebetween; a generally annular bottom half comprising: a bottom interior side and an opposing bottom exterior side with a bottom terminal end extending therebetween; a bottom mating block rigidly attached to said bottom exterior side having a facing side generally coplanar with said bottom terminal end and an opposing threading side with a bore hole extending generally perpendicularly therebetween; and a threaded rod; wherein said generally annular top half and said generally annular bottom half, when joined, are generally annular and circumscribe a volume generally in the shape of a conical frustum, and said top bore hole and said bottom bore hole align to form a contiguous bore hole; wherein said threaded rod is positioned through said contiguous bore hole; and wherein said threaded rod is sufficiently long to extend through both ends of said contiguous bore hole and have two nuts attached at both ends thereof without said generally annular bottom half or said generally annular top half imparting any force on said nuts.

In an embodiment of the die, the contiguous bore hole is generally cylindrical.

In an embodiment of the die, the generally annular top half further comprises: a second top terminal end extending between said top exterior side and said top interior side opposite said top terminal end; a second top mating block rigidly attached to said top exterior side and having a second facing side generally coplanar with said second top terminal end and an opposing second threading side with a bore hole extending generally perpendicularly therebetween; wherein said second facing side is generally coplanar with said facing side; and wherein said generally annular bottom half further comprises: a second bottom terminal end extending between said bottom exterior side and said bottom interior side opposite said bottom terminal end; a second bottom mating block rigidly attached to said bottom exterior side and having a second facing side generally coplanar with said second bottom terminal end and an opposing second threading side with a bore hole extending generally perpendicularly therebetween; wherein said second facing side is generally coplanar with said facing side.

In an embodiment of the die, the top mating block and said bottom mating block are generally in the configuration of a rectangular prism.

In an embodiment of the die, a second top bore hole extends generally perpendicularly through said top mating block generally parallel to said top bore hole and a second bottom bore hole extends generally perpendicularly through said bottom mating block generally parallel to said bottom bore hole and wherein when said top half and said bottom half are joined, said second top bore hole and said second bottom bore hole align to form a second contiguous bore hole.

There is also described herein a tension-relief system comprising: a diameter-reducing die comprising: a generally annular top half comprising: a top interior side and an opposing top exterior side with a top terminal end extending therebetween; a top mating block rigidly attached to said top exterior side and having a facing side generally coplanar with said top terminal end and an opposing threading side with a bore hole extending generally perpendicularly therebetween; a generally annular bottom half comprising: a bottom interior side and an opposing bottom exterior side with a bottom terminal end extending therebetween; a bottom mating block rigidly attached to said bottom exterior side and having a facing side generally coplanar with said bottom terminal end and an opposing threading side with a bore hole extending generally perpendicularly therebetween; wherein said generally annular top half and said generally annular bottom half, when joined, are generally annular and circumscribe a volume generally in the shape of a conical frustum, and said top bore hole and said bottom bore hole align to form a contiguous bore hole; a threaded rod sized and shaped for threading through said contiguous bore hole; two inner threaded nuts sized and shaped for screwing onto opposing ends of said threaded rod when said threaded rod is threaded through said contiguous bore hole; two outer nuts sized and shaped for screwing onto opposing ends of said threaded rod when each one of said two inner threaded nuts is screwed onto opposing ends of said threaded rod in said contiguous bore hole.

There is also described herein a method for incrementally reducing tension on a diameter-reduced die comprising: a tension-relief system comprising: providing a diameter-reducing die comprising: a generally annular top half having a top mating block rigidly attached thereto, said top mating block having a facing side and an opposing threading side with a bore hole extending generally perpendicularly therebetween; a generally annular bottom half having a bottom interior side rigidly attached thereto, said top mating block having a facing side and an opposing threading side with a bore hole extending generally perpendicularly therebetween; wherein said generally annular top half and said generally annular bottom half are joined in a generally annular configuration circumscribing an opening generally in the shape of a conical frustum; and wherein said top bore hole and said bottom bore hole align to form a contiguous bore hole; providing a diameter-reduced pipe liner disposed in said opening and exerting circumferentially outward force on said diameter-reducing die; providing a threaded rod disposed in said contiguous bore hole; providing a top inner nut disposed on said threaded rod generally adjacent to said top threading side; providing a top outer nut disposed on said threaded rod generally adjacent to said top inner nut; providing a bottom inner nut disposed on said threaded rod generally adjacent to said bottom threading side; providing a bottom outer nut disposed on said threaded rod generally adjacent to said bottom inner nut; loosening said top outer nut a fraction of the distance to the top end of said threaded rod such that said top outer nut is not adjacent to said top inner nut; loosening said bottom outer nut a fraction of the distance to the bottom end of said threaded rod such that said bottom outer nut is not adjacent to said bottom inner nut; loosening said top inner nut until said top inner nut is generally adjacent to said top outer nut; loosening said bottom inner nut until said bottom inner nut is generally adjacent to said bottom outer nut; incrementally reducing said circumferentially outward force by repeating the loosening steps of the method until said force is effectively zero.

### BRIEF DESCRIPTION OF THE DRAWINGS

FIG. 1 depicts an embodiment of a prior art process.

FIGS. 2A and 2B depict an embodiment of a pressure relief system layout for an embodiment of a pipe reduction die.

### DESCRIPTION OF THE PREFERRED EMBODIMENT(S)

The following detailed description and disclosure illustrates by way of example and not by way of limitation. This description will clearly enable one skilled in the art to make and use the disclosed systems and apparatus, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

FIG. 2 depicts a side elevation of a pipe reduction die (200) comprising two generally semi-circular halves (201). Die halves (201) generally comprise a half-circular arc of about 180 degrees having two terminal ends (208). When the die (200) is in use, the halves (201) are mated at the terminal ends (208) such that the halves (201) form a general circular die (200). As described elsewhere herein, a pipe liner is compressed by threading the liner through the circular opening in the die (200). The pipe liner tends to retain its compressed state because of, among other things, tension applied longitudinally on the liner. For example, as would be understood by those of ordinary skill in the art, this tension may be supplied at the pulling end by a pulling head attached to a winch, and opposing tension is generally provided by the die (200) assembly, which is securely anchored to the ground to prevent movement, often using steel I-beams and/or heavy logging chains.

The circumferentially inward compression force exerted on the liner by the die (200) to compress the liner as the liner passes through the die (200) results in an opposite tension exerted circumferentially outward against the die (200) by the liner. To hold the halves (201) in place, a mating assembly (202) is used. The depicted mating assembly (202) is essentially a block (209) of strong material generally in the shape of a rectangular prism rigidly attached to the exterior surface, that is, the circumferentially outer surface, of each half (201) at each of the terminal ends (208).

This block (209) is attached so that it is generally flush with the facing ends of the halves (201), allowing the halves (201) to be flushly mated. This is important because, among other things, unevenness in the mating of the halves (201) may scar or damage the liner passing through the die (200), and a gap in the mating would provide a liner passing through the die a non-conformance path whereby the liner could avoid proper compression, causing the compressed portion of the liner to present an irregular profile with protrusions that may become snagged or caught when the liner is threaded through the host pipe.

The block (209) generally has a smooth and generally planar facing surface flush with the facing surface of the terminal ends (208). When the halves (201) are assembled and mated, the facing surfaces of blocks (209) on each half (201) face each other as depicted in the embodiment of FIG. 2. The visual effect of this mating is that opposing blocks (209) on the mated halves (201) appear to be a single block having a latitudinal crease where the facing surfaces are joined.

There is generally cut through the blocks (209) one or more generally cylindrical bore holes (not visible) sized and shaped to accommodate joining hardware. The bore holes generally extend through the block (209) perpendicularly from the facing surface, and are generally aligned in the blocks (209) so that when halves (201) are mated, the bore holes in facing blocks (209) align to present a single bore through both facing blocks (209), such that joining hardware may be inserted through both blocks (209) by inserting such joining hardware through the contiguous, aligned bore holes in both facing blocks (209).

The halves (201) may be secured with joining hardware such as a threaded bolt (207) placed through the aligned bore holes and held in place with a threaded nut (211) tightly rotated onto the threaded end of the bolt (207). The prior art arrangement utilizes a bolt of sufficient length to pass through the bore in both facing blocks (209) and have a nut positioned on the distal end of the bolt. This, however, presents a dangerous condition when the pipe liner is removed from the die (200). In many compressing activities, the liner is removed from the die (200) by unmating the halves (201). Because the outward tension on the halves (201) can exceed multiple tons as the liner in the die (200) is being actively compressed, when the nut (211) is removed from the bolt (207), the tension may tend to cause the nut (211) to violently spring from the bolt (207) in an unpredictable direction, posing a threat to the human operator who is unscrewing the nut (211), or may damage nearby equipment. Further, the two halves (201) can rapidly blow apart, causing one or both the halves (201) to become a dangerous projectile. Moreover, the halves (201) are generally mated at both terminal ends (208) and, if the bolt (207) at one end is loosened to cause the halves (201) to rapidly separate at that end while the other end is still mated, the die (200) may deform or warp out of circle.

The systems and methods described herein reduce this problem by inserting through said aligned bore holes an elongated threaded rod (204). The rod (204) is generally inserted such that an approximately equal amount of the rod (204) extends from each end of the aligned bore holes, and a significant amount of the rod (204) extends from each end of the aligned bore holes. There are typically a plurality of aligned bore hole pairings in an embodiment, each of which has one or more such threaded rods (204) inserted therethrough as described, but it is also specifically contemplated that in an alternative embodiment, only one threaded rod (204) may be used in a mating assembly (202) having multiple bore holes. In such an alternative embodiment, other hardware, including but not limited to a bolt (207) and nut (211), may be used in a bore hole which does not include a threaded rod (204).

The mating assembly (202) is assembled by screwing unto each end of the rod (204) an inner nut (205) and an outer nut (206). These are generally tightened to complete the mating of the halves (201), similar to a bolt (207) and nut (211) assembly. The two-nut assembly effectively provides a locking mechanism by which the nuts do not undergo significant loosening or slipping along the rod (204).

When a liner pipe in the die (200) is to be removed, the outer nuts (206) are loosened an amount, followed by the inner nuts (205). Generally, the outer nuts (206) are loosened a fraction of the length of the rod (204) extending from the bore hole. This is because, among other things, as the inner nut (205) is loosened, the outward circumferential tension exerted on the halves (201) will cause the blocks (209) to separate, effectively causing the block (209) to slide toward the end of the threaded rod (204). By including a double nut system, the outer nuts (206) may be first loosened by an amount and then left in place as the inner nuts (205) are loosened, allowing the halves (201) to gradually or incrementally separate. As the halves (201) widen, the outward circumferential tension on them lessens, eventually reaching a point that nuts (205) and (206) may be safely removed from one or both sides of the rod (204), and the liner may be removed from the die (200).

Generally, the threaded rod (204) is long enough so that the halves (201) can be sufficiently separated to relieve an effective amount of tension on them. In this case, when nuts (205) and (206) are removed from one or both sides of the threaded rod (204), they are not violently or rapidly ejected from the threaded rod (204). This generally means that the length of the rod (204) is such that the rod (204) is longer than the gap between the terminal ends (208) of the halves (201) when the tension is relieved. This length will vary depending upon, among other things, the circumference of the die (200), and the amount of outward circumferential tension on the die (200) from a pipe liner passing through the die (200). This in turn depends on, among other things, the size of the liner and the amount of compression the die imposed on the pipe liner. Generally, the threaded rod (204) is at least three to four times as long as the combined length of the aligned bore holes through the facing blocks (209) to provide more than adequate space for the halves (201) to separate on the rod (204).

Generally, it is preferred that a threaded rod (204) be used in conjunction with a bore hole near the exit of the die (200). This is because, among other things, the outward circumferential pressure on the die (200) is generally greatest at the exit because the interior diameter of the die (200) is smallest at the exit. On the entry side of the die (200), the interior diameter of the die (200) is about the same as the exterior diameter of the liner, so that the liner may be fed into the die (200). Thus, most of the load is on the exit side of the die (200), and by relieving tension on the exit side of the die (200) first, the die (200) may be opened in a more controlled fashion, reducing the risk of injury or damage.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A diameter-reducing die comprising:
a generally annular top half comprising:
a top interior side and an opposing top exterior side with a top terminal end extending therebetween; and
a top mating block rigidly attached to said top exterior side, said top mating block having a facing side generally coplanar with said top terminal end and an opposing threading side with a bore hole extending generally perpendicularly therebetween;
a generally annular bottom half comprising:
a bottom interior side and an opposing bottom exterior side with a bottom terminal end extending therebetween; and
a bottom mating block rigidly attached to said bottom exterior side having a facing side generally coplanar with said bottom terminal end and an opposing threading side with a bore hole extending generally perpendicularly therebetween; and
a threaded rod;
wherein said generally annular top half and said generally annular bottom half, when joined, are generally annular and circumscribe a volume generally in the shape of a conical frustum, and said top bore hole and said bottom bore hole align to form a contiguous bore hole;
wherein said threaded rod is positioned through said contiguous bore hole; and
wherein said threaded rod is sufficiently long to extend through both ends of said contiguous bore hole and have two nuts attached at both ends thereof without said generally annular bottom half or said generally annular top half imparting any force on said nuts.

2. The die of claim 1, wherein said contiguous bore hole is generally cylindrical.

3. The die of claim 1, wherein said top half further comprises:
a second top terminal end extending between said top exterior side and said top interior side opposite said top terminal end; and
a second top mating block rigidly attached to said top exterior side and having a second facing side generally coplanar with said second top terminal end and an opposing second threading side with a bore hole extending generally perpendicularly therebetween;
wherein said second facing side is generally coplanar with said facing side; and
wherein said bottom half further comprises:
a second bottom terminal end extending between said bottom exterior side and said bottom interior side opposite said bottom terminal end; and
a second bottom mating block rigidly attached to said bottom exterior side and having a second facing side generally coplanar with said second bottom terminal end and an opposing second threading side with a bore hole extending generally perpendicularly therebetween;
wherein said second facing side is generally coplanar with said facing side;

4. The die of claim 1, wherein said top mating block and said bottom mating block are generally in the configuration of a rectangular prism.

5. The die of claim 1, wherein a second top bore hole extends generally perpendicularly through said top mating block generally parallel to said top bore hole and a second bottom bore hole extends generally perpendicularly through said bottom mating block generally parallel to said bottom bore hole and wherein when said top half and said bottom half are joined, said second top bore hole and said second bottom bore hole align to form a second contiguous bore hole.

6. A tension-relief system comprising:
a diameter-reducing die comprising:
a generally annular top half comprising:
a top interior side and an opposing top exterior side with a top terminal end extending therebetween; and
a top mating block rigidly attached to said top exterior side and having a facing side generally coplanar with said top terminal end and an opposing threading side with a bore hole extending generally perpendicularly therebetween;
a generally annular bottom half comprising:
a bottom interior side and an opposing bottom exterior side with a bottom terminal end extending therebetween; and
a bottom mating block rigidly attached to said bottom exterior side and having a facing side generally coplanar with said bottom terminal end and an opposing threading side with a bore hole extending generally perpendicularly therebetween;
wherein said generally annular top half and said generally annular bottom half, when joined, are generally annular and circumscribe a volume generally in the shape of a conical frustum, and said top bore hole and said bottom bore hole align to form a contiguous bore hole;
a threaded rod sized and shaped for threading through said contiguous bore hole;
two inner threaded nuts sized and shaped for screwing onto opposing ends of said threaded rod when said threaded rod is threaded through said contiguous bore hole; and
two outer nuts sized and shaped for screwing onto opposing ends of said threaded rod when each one of said two inner threaded nuts is screwed onto opposing ends of said threaded rod in said contiguous bore hole.

7. A method for incrementally reducing tension on a diameter-reduced die comprising:
a tension-relief system comprising:
providing a diameter-reducing die comprising:
a generally annular top half having a top mating block rigidly attached thereto, said top mating block having a facing side and an opposing threading side with a bore hole extending generally perpendicularly therebetween;
a generally annular bottom half having a bottom interior side rigidly attached thereto, said top mating block having a facing side and an opposing threading side with a bore hole extending generally perpendicularly therebetween;
wherein said generally annular top half and said generally annular bottom half are joined in a generally annular configuration circumscribing an opening generally in the shape of a conical frustum; and
wherein said top bore hole and said bottom bore hole align to form a contiguous bore hole;
providing a diameter-reduced pipe liner disposed in said opening and exerting circumferentially outward force on said diameter-reducing die;
providing a threaded rod disposed in said contiguous bore hole;
providing a top inner nut disposed on said threaded rod generally adjacent to said top threading side;
providing a top outer nut disposed on said threaded rod generally adjacent to said top inner nut;
providing a bottom inner nut disposed on said threaded rod generally adjacent to said bottom threading side;
providing a bottom outer nut disposed on said threaded rod generally adjacent to said bottom inner nut;
loosening said top outer nut a fraction of the distance to the top end of said threaded rod such that said top outer nut is not adjacent to said top inner nut;
loosening said bottom outer nut a fraction of the distance to the bottom end of said threaded rod such that said bottom outer nut is not adjacent to said bottom inner nut;
loosening said top inner nut until said top inner nut is generally adjacent to said top outer nut;
loosening said bottom inner nut until said bottom inner nut is generally adjacent to said bottom outer nut; and
incrementally reducing said circumferentially outward force by repeating the loosening steps of the method until said force is effectively zero.
